(19) United States
(12) Patent Application Publication
(10) Pub. No.: US 2007/0055575 A1
(43) Pub. Date: Mar. 8, 2007

(54) AUTOMATED ORDER BOOK RECONCILIATION PROCESS

(75) Inventors: Stephen T. McDonald, Staatsburg, NY (US); Anthony V. Ferreri, Hyde Park, NY (US); Richard J. Lukes, Denver, NC (US); Michael T. Phelan, Milton, NY (US)

Correspondence Address: DELIO & PETERSON, LLC, 121 WHITNEY AVENUE, NEW HAVEN, CT, 06510, US

(73) Assignee: INTERNATIONAL BUSINESS MACHINES CORPORATION, Armonk, NY (US)

(21) Appl. No.: 11/161,629

(22) Filed: Aug. 10, 2005

(51) Int. Cl. G06Q 30/00

(52) U.S. Cl. 705/26

(57) ABSTRACT

Methods, systems and apparatus for determining a current state of an order book for order request reconciliation. A customer inputs an order request for a desired quantity of items to be shipped to a recipient into the system. A supplier inputs a shipment quantity of any such previously shipped items into an input table, while a recipient inputs into another table a receipt quantity of any such received items. These input shipment and receipt quantities are then transmitted to a reconciliation program of the system for determining an in-transit quantity that is used along with the receipt quantity to generate an updated, current state of the order book. This current state of the order book substantially avoids any over-shipments, under-shipments and unwanted inventory returns. A Materials Requirement Planning component then generates an order book reconciliation output table for viewing by users using the current state of the order book.

### BACKGROUND OF THE INVENTION

1. Field of the Invention

The present invention is directed generally to processing order requests, and in particular, to methods, systems and apparatus for interactive order book reconciliation for automatically providing a current state of the order book at a time of requesting an order.

2. Description of Related Art

Today, when an order is requested from a supplier, prior to shipping the order, the supplier often first performs a manual order book reconciliation to determine the current state of the order book. This current state of the order book includes information relating to the number of items requested in an order, the number of such items that have already been shipped and/or received by a recipient, and the number of items needed to fulfill and complete the order. FIG. 1 shows a conventional order book reconciliation process whereby the state of the order book is determined in step 10, and then once determined, this information is input into a Central Planning Engine (CPE) for running a Materials Requirement Planning (MRP) in step 30. The MRP determines the number of items needed to fulfill and complete an order.

However, conventional manual order book reconciliation and MRP processes are undesirably one-dimensional since they utilize information gathered and supplied only by the supplier. For instance, Inter-Company Enterprise suppliers and Interplant Supplying Sites, as well as, Integrated Contract Manufacturing (CM) Suppliers, are often the only entity to actively participate within conventional manual order book reconciliation and MRP processes. The one requesting the order, or the recipient of such order, does not actively participate in conventional manual order book reconciliation and MRP processes.

As such, these conventional approaches are burdensome on the supplier since the supplier must examine its records to determine whether any of the requested order has been previously shipped and/or determine whether any of such order has been received by the receiving party, which may involve contacting the orderer and/or recipient. Also, since conventional manual order book reconciliation approaches are generally performed and generate a state of the order book well before requesting an order, this state of the order book is often outdated at the time of requesting an order and at the time of running the MRP. This undesirably often requires rerunning both the manual order book reconciliation and MRP processes and leads to under-shipments of requested inventory, over-shipments of requested inventory, and supplier over-stock due to unwanted inventory returns.

Accordingly, a need exists in the art for improved methods, systems and apparatus for an interactive ordering request reconciliation that automatically determines a current state of the order book at the time of requesting an order.

### SUMMARY OF THE INVENTION

Bearing in mind the problems and deficiencies of the prior art, it is therefore an object of the present invention to provide interactive, automated order book reconciliation methods, systems and apparatus that take into account both previously shipped and already received inventory relating to an order request.

Another object of the present invention is to provide interactive, automated order book reconciliation methods, systems and apparatus that employ a current state of the order book at the time of ordering.

It is another object of the present invention to provide interactive, automated order book reconciliation methods, systems and apparatus that balance the pipeline inventory setting up the Materials Requirement Planning (MRP) so that the MRP runs with the most current state of the order book at the time of order requesting, processing and shipment.

A further object of the invention is to provide interactive, automated order book reconciliation methods, systems and apparatus that avoid reruns of the manual order book state and MRP, avoid under-shipment and over-shipment of requested inventory, and avoid undesired supplier over-stock.

It is yet another object of the present invention to provide interactive, automated order book reconciliation methods, systems and apparatus that employ manual order book reconciliation information supplied by the one ordering and/or the recipient of the requested order.

Yet another object of the present invention is to provide interactive, automated order book reconciliation methods, systems and apparatus that employ a combination of manual order book reconciliation information supplied by the supplier, the one ordering and the recipient of the order.

Still another object of the present invention is to provide interactive, automated order book reconciliation methods, systems and apparatus that more precisely fulfill the requirements of an order request.

Other objects and advantages of the invention will in part be obvious and will in part be apparent from the specification.

The above and other objects, which will be apparent to those skilled in art, are achieved in the present invention, which is directed to in a first aspect a method of determining a current state of an order book for order request reconciliation. The method includes inputting an order request for a desired quantity of items; inputting a shipment quantity of such previously shipped items and inputting a receipt quantity of the received previously shipped items. An in-transit quantity of such items is then determined using the shipment quantity and the receipt quantity. Using these in-transit and receipt quantities, a current state of an order book is generated by calculating a remainder quantity of the items needed to equal the desired quantity of items in the order request.

In accordance with the invention, a customer preferably inputs the order request for the desired quantity of items to be shipped to a recipient, while the recipient inputs the receipt quantity of the items already received. This recipient may be the customer or a third entity receiving party. A supplier inputs the shipment quantity of the items shipped to the recipient. The supplier may be an inter-enterprise wide supplier, an intra-enterprise wide supplier or combinations thereof.

In this aspect, the invention further includes transmitting the input shipment quantity and the input receipt quantity to a reconciliation program for determining the in-transit quantity of the items by balancing the shipment quantity against the receipt quantity. The reconciliation program preferably automatically generates the current state of the order book. The current state of the order book is then transmitted to a Materials Requirement Planning component, which generates an order book reconciliation output table for viewing by users.

In accordance with the invention, the current state of the order book substantially avoids any over-shipments, under-shipments and unwanted inventory returns, may be generated systematically in real-time, and/or may be generated at a time of requesting the order request. Further, this current state of the order book may be refreshed using updates to the shipment quantity and updates to the receipt quantity that occur from the time of requesting the order request until a later time of submitting the order request. In so doing, the refreshed state of the order book is systematically generated substantially in real-time. Refreshing the current state of the order book is done by the present system and may be initiated manually by a user of the invention, or automatically by the present system prior to acceptance of the order request.

In another aspect, the invention is directed to a system for determining a current state of an order book for order request reconciliation. The system includes an input table for inputting a shipment quantity of previously shipped items relating to an order request for a desired quantity of the items, and another input table for inputting a receipt quantity of the received shipped items. A reconciliation program of the system automatically determines an in-transit quantity of the items based on the shipment quantity and the receipt quantity. The reconciliation program also determines a current state of an order book by calculating a remainder quantity of the items needed to equal the desired quantity of items in the order request using the in-transit quantity and the receipt quantity. A Materials Requirement Planning component of the system generates an order book reconciliation output table for viewing by users.

In still another aspect, the invention is directed to a program storage device readable by a processor capable of executing instructions, tangibly embodying a program of instructions executable by the processor to perform method steps for determining a current state of an order book for order request reconciliation. The method steps include inputting an order request for a desired quantity of items, inputting a shipment quantity of previously shipped the items and inputting a receipt quantity of the previously shipped items. An in-transit quantity of such items is then determined using the shipment quantity and the receipt quantity, followed by generating a current state of an order book. Using the in-transit quantity and the receipt quantity, the current state of the order book is then generated by calculating a remainder quantity of the items needed to equal the desired quantity of items in the order request.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a prior art illustration of a manual order book reconciliation process flow.

FIG. 2 is an automated order book reconciliation process flow of the invention.

### DESCRIPTION OF THE PREFERRED EMBODIMENT(S)

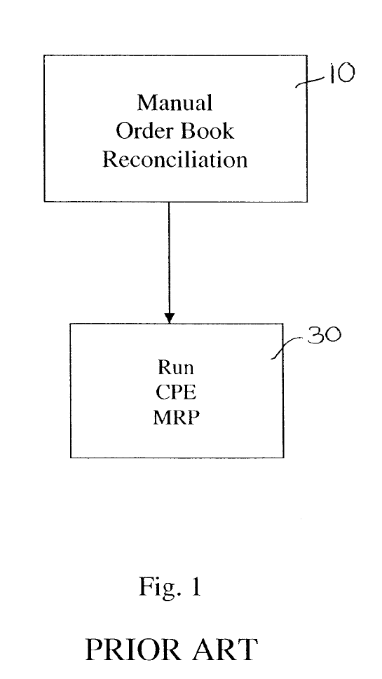

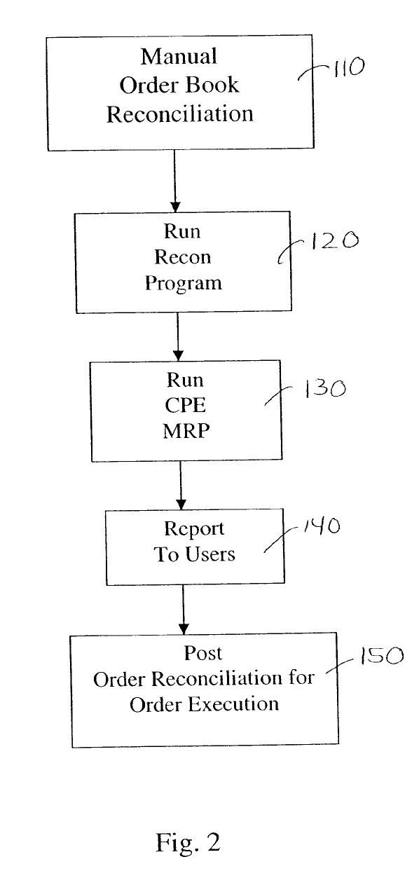

In describing the preferred embodiment of the present invention, reference will be made herein to FIGS. 1-2 of the drawings in which like numerals refer to like features of the invention.

The present invention is directed to methods, systems and apparatus for an interactive order book reconciliation that automatically provides an updated, current state of an order book at a time of ordering. This state or condition of the order book identifies, amongst other variables, the number of items remaining or needed to complete an order request. The invention provides order book reconciliation by taking into account both previously shipped and already received inventory relating to an order request for determining any in-transit inventory, which is used to generate a current state of the order book at the time of requesting an order, and more preferably at a time of submitting an order. It should be appreciated and understood that an order may be requested at one point in time, and actually submitted or placed with the supplier at a later point in time.

The invention balances the pipeline inventory input into the Materials Requirement Planning (MRP) of the system so that the MRP runs with the most current state of the order book at a time of order requesting and/or submission, processing and shipment. In so doing, the invention substantially avoids the need for redetermining the state of the order book and the need for rerunning the MRP. This in turn leads to a significant reduction in under-shipments of requested inventory, over-shipments of requested inventory, and the undesired supplier over-stock of returned inventory.

For ease of understanding the invention, FIG. 2 illustrates a preferred embodiment of the interactive, automated order book reconciliation process flow of the invention. It should be appreciated that components of the present invention may be embodied as a computer program product stored on a program storage device. These program storage devices may be devised, made and used as a component of a machine that utilizes optics, magnetic properties and/or electronics to perform certain of the method steps of the present invention. Such program storage devices may include, but are not limited to, magnetic media such as diskettes or computer hard drives, magnetic tapes, optical disks, Read Only Memory (ROM), floppy disks, semiconductor chips and the like. A computer readable program code means in known source code may be employed to convert certain of the method steps described below. This computer readable program code contains instructions embodied in tangible media, such as floppy disks, CD-ROMS, hard drives, or any other computer-readable storage medium, wherein, when the computer program code is loaded into and executed by a computer, the computer becomes an apparatus for practicing the invention.

In accordance with the invention, it should be appreciated that a customer may be the actual orderer and the recipient of the requested order. Alternatively, the customer and recipient may be separate entities, whereby the recipient of the requested order is a third entity receiving party. As such, the customer inputs into the present system may include the orderer of the requested order inputting purchase order information for itself, the orderer inputting purchase order information for a third entity receiving party (i.e., recipient), a third entity receiving party of the requested order inputting purchase order information, or even combinations thereof. The supplier may be an Inter-Company Enterprise Supplier supplying site or an Integrated Contract Manufacturing (CM) Supplier, an Intra-Company Enterprise supplier, such as an Interplant “Partnering” Location, and the like.

In the invention, both a supplier of the order request, a customer affiliated with such requested order, and a recipient of the order input purchase order information into the present manual order book reconciliation process (step 110). In so doing, a supplier inputs shipped inventory data into a table of the system. This shipped inventory data at least includes a quantity of such shipped inventory, as well as various other data relating to inventory already shipped to a particular recipient (e.g., the orderer or a third entity receiving party) that would fulfill, or partially fulfill, a requested purchase order. For instance, the shipped inventory data may include, but is not limited to, site shipments, segment length, site shipment location, site shipment group, plant interface code, an item identifier, order location, customer number code, order number group, order number, line item number, delivery schedule line number, number of shipment buckets, shipment bucket identifiers, date shipped (from supplier), quantity shipped (from supplier), and combinations thereof.

The customer makes a request for an order (i.e., the orderer), which at least includes the quantity of inventory desired. Again, this ordering customer may be the recipient of the order request, or a third party receiving party may be the recipient. The recipient of the order then inputs received shipment data into another table of the system that at least includes a quantity of received shipment inventory that would fulfill or partially fulfill the requirements of the requested order, as well as other data relating to the order requested. For instance, this received shipment data may include, but is not limited to, site receipts, segment length, site receipt group, site receipt location, plant interface code, an item identifier, code specific supplier, vendor number group, order number group, order number, line item number, delivery schedule line number, number of receipt buckets, receipt bucket identifiers, date received (to stock), quantity received (to stock), and combinations thereof.

Once the supplier has input shipped inventory data and the customer (i.e., orderer or recipient of the order) has input received shipment data into the present system, this information is transmitted and input into a reconciliation program of the system and stored in a database therein (step 120). The orderer requests the order for a specific quantity of items, and then this request, along with the desired quantity, is stored in an order book. The reconciliation program then takes the two essential types of input data transactions, and automatically determines a quantity of in-transit shipments that have been shipped from the supplier to the recipient, which would fulfill, or partially fulfill, the open order request. This quantity of in-transit shipments is determined by the reconciliation program balancing the input shipped inventory data against the input received shipment data.

The reconciliation program then generates an updated, current state of the order book using the quantity of in-transit shipments and the quantity of input received shipment data. In so doing, the quantity of in-transit shipments and the quantity of input received shipment data are both subtracted from the quantity of items specified in the order request residing in the stored state of the order book. This calculation provides a precise quantity of remaining items needed to fulfill and complete the order request, which is stored to generate an updated, current state of the order book. Of course, the quantity of the in-transit shipments and previously received shipments can be netted together and then subtracted from the requested quantity in the order request. This updated, current state of the order book is automatically generated upon making an order request.

Once the reconciliation program generates the updated, current state of the order book, the reconciliation program initializes the MRP and transmits the updated, current state of the order book information to the MRP (step 130). The MRP then generates an order book reconciliation report using the updated order book, which is output (step 140) and posted for display by users of the invention (step 150). This order book reconciliation report is preferably an output table displayed and viewed locally by users. The output tables display various data relating to the updated order book including, but not limited to, item numbers, shipping location, customer location, vendor number, a quantity of items currently in transit to a designated recipient that could be used to fill an order request, a quantity of items already received by such recipient that could be used to fill the order request, a remaining quantity of such items needed to fulfill and complete the order request, and combinations thereof. Using the information displayed in the order book reconciliation report of the invention, a user is then able to precisely submit a purchase order for an appropriate quantity of items that would fulfill and complete the requested order, while substantially avoiding any over-shipments, under-shipments and unwanted inventory returns.

Since the present order book reconciliation is preferably an automated system running substantially in real-time, users of the invention are advantageously provided with the most currently available purchase order information. As such, the updated current state of the order book is systematically generated substantially in real-time at a time of requesting an order.

However, wherein there is a lag time between when a customer requests an order and actually purchases such order, the current state of the order book may be refreshed for more accurately ordering a desired quantity of items. Either the supplier or the customer may manually initiate this refresh step for the system to process, or it may be automatically initiated and performed by the system prior to accepting a purchase order. The refreshed order book is generated using any updates to the two transactions input by the suppliers and the customers into the present system from a time of requesting the order until a later time of actually submitting (i.e., the orderer placing and/or the supplier accepting) the order. When a refresh step is performed, the MRP generates refreshed output tables using the refreshed state of the order book. These refreshed output tables are displayed to the users for allowing even more precise fulfillment of the original order request, such that, over- and under-shipments and unwanted inventory returns are even further avoided.

An advantage is that both inter-enterprise wide suppliers (i.e., interplant within a company) and intra-enterprise wide suppliers (i.e., suppliers or business partners outside the company) may use the present invention. For example, if customer D orders from internal supplier R who, in turn, orders from external supplier H, and external supplier H ships directly to both internal supplier R and customer D, then external supplier H would input into the present system quantity X of requested items in-transit to internal supplier R and quantity Y of requested items in-transit to customer D. Once the items are received by both recipients, then internal supplier R would input a receipt of quantity X of requested items received from supplier H, and customer D would input a receipt of quantity Y of requested items received from supplier H.

As another example of the invention, wherein customer A would like to purchase 100 widgets from supplier B and ship them to recipient C, customer A first signs into the present system and makes a request for 100 widgets. Customer A is informed from the posted order reconciliation report that recipient C has previously received 10 widgets that would fulfill a portion of the order request (i.e., recipient C has previously input receipts of 10 widgets into the system), and that a first set of 30 widgets and a second set of 10 widgets, both of which would fulfill a portion of such order request, have been shipped to recipient C (i.e., supplier B has input shipment data into the system verifying shipment of the 30 and 10 widgets to recipient C.) The reconciliation program of the system compares the shipment inputs against the receipt inputs and determines that the 10 widgets received by recipient C are in fact the second set of 10 widgets shipped to recipient C. By comparing these inputs, the reconciliation program also determines that the first set of 30 widgets shipped to recipient C are actually in-transit to recipient C. The reconciliation program then subtracts the 10 received widgets and the 30 in-transit widgets from the 100 requested widgets to provide a balance of 60 widgets needed to fulfill and complete the order request. This balance of widgets is displayed to customer A in the posted order reconciliation report, preferably in substantially real-time, such that customer A places an order for the remaining 60 widgets needed to fulfill and complete the order request. Advantageously, over-shipments and under-shipments to recipient C, and unwanted inventory returns to supplier B, are avoided. The invention is particularly useful for customers having standing orders with a supplier wherein such supplier routinely ships orders to the customer on a periodic basis.

Again, a critical feature is that once the local system inputs the receipts and shipments into the system, the invention auto-reconciles the orders to demand by checking the input receipts against the input shipments to determine (i.e., calculate) the actual in-transit inventory. The calculated in-transit inventory is advantageously used to avoid over-ordering and/or under-ordering of the remaining items needed to fulfill and complete the order request, and thereby reducing unwanted inventory returns to the supplier. The invention is also beneficial since visibility and prevention capabilities are now provided to a Materials Parts Planning Cycle to Cycle, thereby significantly reducing both excess inventory stocks (e.g., from both under- and over-planning inventory exposures), as well as reducing over-expenditures from both the supplier's and the customer's perspectives. By utilizing the in-transit inventory shipment data, the present automated order book reconciliation system enables the customer's view of demand to be used in calculating the forecast demand, and thereby provides a more accurate forecast of the required number of items or inventory needed to fulfill and complete a requested order.

The invention advantageously balances the pipeline inventory used in setting-up the MRP so that the MRP runs with the most currently available information relating to the order request. This balanced pipeline inventory includes summarized “shipment” and “receipt” transactions that are merged to calculate an “in-transit” record for the in-transit supply. The customer then uses the calculated in-transit supply quantity during the MRP run to reduce the order quantity (open or planned) against a supplying location, and to reduce forecast quantities. In effect, the invention nets the supplier's demands against the orders bridged in by the orderer for changing the overall view of the MRP from the Suppliers demand view to the orderers demand view.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A method of determining a current state of an order book for order request reconciliation comprising:
inputting an order request for a desired quantity of items;
inputting a shipment quantity of previously shipped said items;
inputting a receipt quantity of received said previously shipped items;
determining an in-transit quantity of said items using said shipment quantity and said receipt quantity; and
generating a current state of an order book by calculating a remainder quantity of said items needed to equal said desired quantity of items in said order request using said in-transit quantity and said receipt quantity.

2. The method of claim 1 wherein said inputting steps further comprise:
a customer inputting said order request for said desired quantity of items to be shipped to a recipient;
a supplier inputting said shipment quantity of said items shipped to said recipient; and
said recipient inputting said receipt quantity of said items already received.

3. The method of claim 2 wherein said customer comprises said recipient.

4. The method of claim 2 wherein said recipient comprises a third entity receiving party.

5. The method of claim 2 wherein said supplier is selected from the group consisting of an inter-enterprise wide supplier, an intra-enterprise wide supplier and combinations thereof.

6. The method of claim 2 wherein said supplier inputs said shipment quantity into a shipped inventory data table along with shipped inventory data selected from the group consisting of site shipments, segment length, site shipment location, site shipment group, plant interface code, an item identifier, order location, customer number code, order number group, order number, line item number, delivery schedule line number, number of shipment buckets, shipment bucket identifiers, date shipped, and combinations thereof.

7. The method of claim 2 wherein said recipient inputs said receipt quantity into an received inventory table along with received shipment data selected from the group consisting of site shipments, segment length, site shipment location, site shipment group, plant interface code, an item identifier, order location, customer number code, order number group, order number, line item number, delivery schedule line number, number of shipment buckets, shipment bucket identifiers, date shipped, and combinations thereof.

8. The method of claim 1 further including the step of transmitting said input shipment quantity and said input receipt quantity to a reconciliation program for determining said in-transit quantity of said items by balancing said shipment quantity against said receipt quantity.

9. The method of claim 8 wherein said reconciliation program automatically generates said current state of said order book.

10. The method of claim 9 further including the step of transmitting said current state of said order book to a Materials Requirement Planning component for generating an order book reconciliation output table for viewing by users.

11. The method of claim 10 said order book reconciliation output table includes displays selected from the group consisting of item numbers, shipping location, customer location, vendor number, a quantity of items currently in transit to a designated recipient that could be used to fill an order request, a quantity of items already received by such recipient that could be used to fill the order request, a remaining quantity of such items needed to fulfill and complete the order request, and combinations thereof.

12. The method of claim 1 wherein said current state of said order book substantially avoids any over-shipments, under-shipments and unwanted inventory returns.

13. The method of claim 1 wherein said current state of said order book is generated systematically in real-time.

14. The method of claim 1 wherein said current state of said order book is generated at a time of requesting said order request.

15. The method of claim 14 further including refreshing said current state of said order book subsequent to said time of requesting said order request.

16. The method of claim 15 wherein said current state of said order book is refreshed using updates to said shipment quantity and updates to said receipt quantity from said time of requesting said order request until a later time of submitting said order request.

17. The method of claim 15 wherein said current state of said order book is refreshed manually.

18. The method of claim 15 wherein said current state of said order book is refreshed automatically prior to accepting said order request.

19. A system for determining a current state of an order book for order request reconciliation comprising:
a first input table for inputting a shipment quantity of previously shipped items relating to an order request for a desired quantity of said items;
a second input table for inputting a receipt quantity of received said previously shipped items;
a reconciliation program for automatically determining an in-transit quantity of said items based on said shipment quantity and said receipt quantity, and then determining a current state of an order book by calculating a remainder quantity of said items needed to equal said desired quantity of items in said order request using said in-transit quantity and said receipt quantity; and
a Materials Requirement Planning component for generating an order book reconciliation output table for viewing by users.

20. A program storage device readable by a processor capable of executing instructions, tangibly embodying a program of instructions executable by the processor to perform method steps for determining a current state of an order book for order request reconciliation, said method steps comprising:
inputting an order request for a desired quantity of items;
inputting a shipment quantity of previously shipped said items;
inputting a receipt quantity of said previously shipped items;
determining an in-transit quantity of said items using said shipment quantity and said receipt quantity; and
generating a current state of an order book by calculating a remainder quantity of said items needed to equal said desired quantity of items in said order request using said in-transit quantity and said receipt quantity.
